(19) United States
(12) Patent Application Publication
(10) Pub. No.: US 2020/0227049 A1
(43) Pub. Date: Jul. 16, 2020

(54) METHOD, APPARATUS AND DEVICE FOR WAKING UP VOICE INTERACTION DEVICE, AND STORAGE MEDIUM

(71) Applicant: Baidu Online Network Technology (Beijing) Co., Ltd, Beijing (CN)

(72) Inventors: Yong Liu, Beijing (CN); Ji Zhou, Beijing (CN); Xiangdong Xue, Beijing (CN); Peng Wang, Beijing (CN); Lifeng Zhao, Beijing (CN)

(73) Assignee: Baidu Online Network Technology (Beijing) Co., Ltd., Beijing (CN)

(21) Appl. No.: 16/601,635

(22) Filed: Oct. 15, 2019

(30) Foreign Application Priority Data
Jan. 11, 2019 (CN) 201910026336.8

(51) Int. Cl. G10L 17/00; G10L 17/06; G10L 17/04

(52) U.S. Cl. CPC G10L 17/005; G10L 17/04; G10L 17/06

(57) ABSTRACT

A method, apparatus, and device for waking up a voice interaction device, and a storage medium are provided. The method includes: acquiring a voice signal; extracting a first voiceprint characteristic of the voice signal; comparing the first voiceprint characteristic with a pre-stored reference voiceprint characteristic to obtain a similarity between the first voiceprint characteristic and the pre-stored reference voiceprint characteristic; comparing the similarity with a preset threshold; and determining that the first voiceprint characteristic is consistent with the reference voiceprint characteristic in response to the similarity larger than the preset threshold; and determining a wake-up word included in content of the voice signal by using a wake-up word recognition model and waking up the voice interaction device. In the embodiments, the ratio for falsely waking up a voice interactive device is reduced.

### CROSS-REFERENCE TO RELATED APPLICATION

This application claims priority to Chinese patent application No. 201910026336.8, filed on Jan. 11, 2019, which is hereby incorporated by reference in its entirety.

### TECHNICAL FIELD

The present application relates to a field of voice interaction technology, and in particular, to a method, apparatus and device for waking up a voice interaction device, and a storage medium.

### BACKGROUND

Existing voice interactive devices may be woken up falsely. For example, the voice interactive device may be woken up falsely in response to a voice signal from a device such as a television or a radio. Alternatively, in a case that a wake-up word is not included in a user's voice, the wake-up word may still be erroneously recognized from the user's voice, and the device is thus woken up falsely. The false wake-up may lead to a poor user experience.

### SUMMARY

A method and apparatus for waking up a voice interaction device are provided according to embodiments of the present application, so as to at least solve the above technical problems in the existing technology.

In a first aspect, a method for waking up a voice interaction device is provided according an embodiment of the present application. The method includes: acquiring a voice signal, extracting a first voiceprint characteristic of the voice signal; comparing the first voiceprint characteristic with a pre-stored reference voiceprint characteristic to obtain a similarity between the first voiceprint characteristic and the pre-stored reference voiceprint characteristic; comparing the similarity with a preset threshold; and determining that the first voiceprint characteristic is consistent with the reference voiceprint characteristic in response to the similarity larger than the preset threshold; and determining a wake-up word included in content of the voice signal by using a wake-up word recognition model and waking up the voice interaction device.

In an implementation, the method further includes: pre-storing a plurality of reference voiceprint characteristics. The comparing the first voiceprint characteristic with a pre-stored reference voiceprint characteristic to obtain a similarity between the first voiceprint characteristic and the pre-stored reference voiceprint characteristic, comparing the similarity with a preset threshold, and determining that the first voiceprint characteristic is consistent with the reference voiceprint characteristic in response to the similarity larger than the preset threshold includes: comparing the first voiceprint characteristic with pre-stored reference voiceprint characteristics to obtain similarities between the first voiceprint characteristic and the respective pre-stored reference voiceprint characteristics; comparing the similarities with a preset threshold; and determining that the first voiceprint characteristic is consistent with one of the reference voiceprint characteristics in response to the similarity between the first voiceprint characteristic and the one of the reference voiceprint characteristics larger than the preset threshold.

In an implementation, the method further includes determining the reference voiceprint characteristic by acquiring a voice signal of a user, extracting a second voiceprint characteristic of the voice signal of the user, and determining the second voiceprint characteristic as the reference voiceprint characteristic.

In an implementation, the method further includes establishing a wake-up word recognition model associated with the reference voiceprint characteristic in advance. And the determining a wake-up word included in content of the voice signal by using a wake-up word recognition model includes: determining a reference voiceprint characteristic consistent with the first voiceprint characteristic, obtaining a wake-up word recognition model associated with the determined reference voiceprint characteristic, and determining the voice signal by using the obtained wake-up word recognition model.

In an implementation, the establishing a wake-up word recognition model associated with the reference voiceprint characteristic in advance includes training the wake-up word recognition model with a positive sample and a negative sample having the reference voiceprint characteristic, wherein the positive sample is a voice signal including the wake-up word and capable of waking up the voice interaction device, and the negative sample is a voice signal that does not include the wake-up word and is capable of waking up the voice interactive device.

In a second aspect, an apparatus for waking up a voice interaction device is provided according an embodiment of the present application. The apparatus includes: an acquirement module configured to acquire a voice signal, an extraction module configured to extract a first voiceprint characteristic of the voice signal, a comparison module configured to compare the first voiceprint characteristic with a pre-stored reference voiceprint characteristic to obtain a similarity between the first voiceprint characteristic and the pre-stored reference voiceprint characteristic, compare the similarity with a preset threshold, and determine that the first voiceprint characteristic is consistent with the reference voiceprint characteristic in response to the similarity larger than the preset threshold, and a determination and waking-up module configured to determine a wake-up word included in content of the voice signal by using a wake-up word recognition model and to wake up the voice interaction device.

In an implementation, the apparatus further includes a voiceprint storing module configured to store a plurality of reference voiceprint characteristics. The comparison module is further configured to compare the first voiceprint characteristic with pre-stored reference voiceprint characteristics to obtain similarities between the first voiceprint characteristic and the respective pre-stored reference voiceprint characteristics, to compare the similarities with a preset threshold, and determine that the first voiceprint characteristic is consistent with one of the reference voiceprint characteristics in response to the similarity between the first voiceprint characteristic and the one of the reference voiceprint characteristics larger than the preset threshold.

In an implementation, the apparatus further includes a voiceprint determination module configured to acquire a voice signal of a user, extract a second voiceprint characteristic of the voice signal of the user, and determine the second voiceprint characteristic as the reference voiceprint characteristic.

In an implementation, the apparatus further includes a model establishment module configured to establish a wake-up word recognition model associated with the reference voiceprint characteristic in advance. And the determination and waking-up module is further configured to determine a reference voiceprint characteristic consistent with the first voiceprint characteristic, obtain a wake-up word recognition model associated with the determined reference voiceprint characteristic, and determine the voice signal by using the obtained wake-up word recognition model.

In an implementation, the model establishment module is further configured to train the wake-up word recognition model with a positive sample and a negative sample having the reference voiceprint characteristic, wherein the positive sample is a voice signal including the wake-up word and capable of waking up the voice interaction device, and the negative sample is a voice signal that does not include the wake-up word and is capable of waking up the voice interactive device.

In a third aspect, a device for waking up a voice interaction device is provided according an embodiment of the present application. The functions of the device may be implemented by using hardware or by corresponding software executed by hardware. The hardware or software includes one or more modules corresponding to the functions described above.

In a possible embodiment, the device structurally includes a processor and a memory, wherein the memory is configured to store a program which supports the device in executing the above method for waking up a voice interaction device. The processor is configured to execute the program stored in the memory. The device may further include a communication interface through which the device communicates with other devices or communication networks.

In a fourth aspect, a computer-readable storage medium for storing computer software instructions used for a device for waking up a voice interaction device is provided. The computer-readable storage medium may include programs involved in executing of the method for waking up a voice interaction device described above.

One of the above technical solutions has the following advantages or beneficial effects: in embodiments of the present application, after a voice signal is acquired, it is firstly determined whether a similarity between a voiceprint characteristic of the voice signal and a pre-stored reference voiceprint characteristic is larger than a preset threshold. In case that the similarity is larger than the preset threshold, it is determined that the voiceprint characteristic of the voice signal is consistent with the pre-stored reference voiceprint characteristic. Then, a wake-up word included in content of the voice signal is determined by using a wake-up word recognition model, and the voice interaction device is woken up. Through the step-by-step determinations, the ratio for falsely waking up a voice interactive device can be reduced.

The above summary is provided only for illustration and is not intended to be limiting in any way. In addition to the illustrative aspects, embodiments, and features described above, further aspects, embodiments, and features of the present application will be readily understood from the following detailed description with reference to the accompanying drawings.

### BRIEF DESCRIPTION OF THE DRAWINGS

In the drawings, unless otherwise specified, identical or similar parts or elements are denoted by identical reference numerals throughout the drawings. The drawings are not necessarily drawn to scale. It should be understood these drawings merely illustrate some embodiments of the present application and should not be construed as limiting the scope of the present application.

FIG. 1 is a flowchart showing an implementation of a method for waking up a voice interaction device according to an embodiment of the present application;

FIG. 2 is a schematic structural diagram showing an apparatus for waking up a voice interaction device according to an embodiment of the present application;

FIG. 3 is a schematic structural diagram showing an apparatus for waking up a voice interaction device according to an embodiment of the present application; and

FIG. 4 is a schematic structural diagram showing an apparatus for waking up a voice interaction device according to an embodiment of the present application.

### DETAILED DESCRIPTION OF THE EMBODIMENTS

Hereafter, only certain exemplary embodiments are briefly described. As can be appreciated by those skilled in the art, the described embodiments may be modified in different ways, without departing from the spirit or scope of the present application. Accordingly, the drawings and the description should be considered as illustrative in nature instead of being restrictive.

A method and apparatus for waking up a voice interactive device are provided according to embodiments of the present application. The technical solutions are described below in detail by means of the following embodiments.

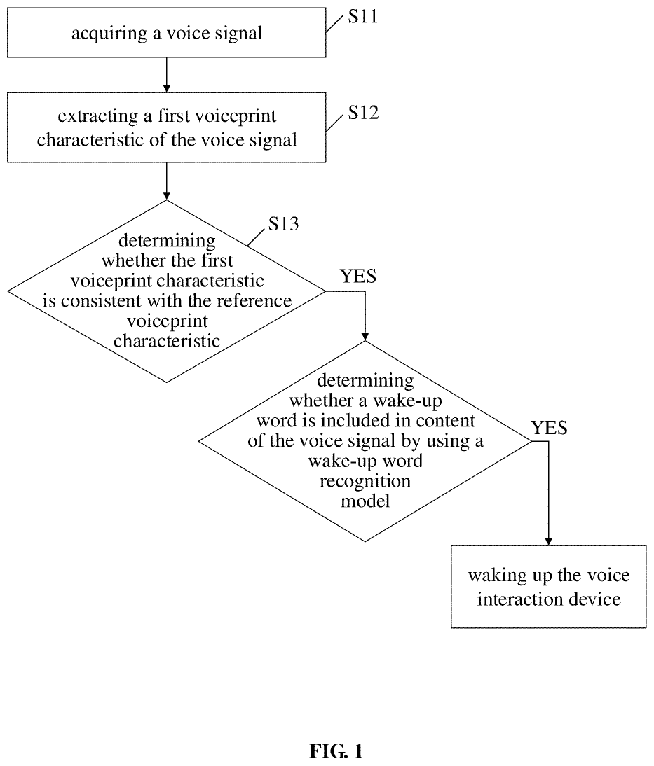

FIG. 1 is a flowchart showing an implementation of a method for waking up a voice interaction device according to an embodiment of the present application. The method includes: acquiring a voice signal at S11, extracting a first voiceprint characteristic of the voice signal at S12, comparing the first voiceprint characteristic with a pre-stored reference voiceprint characteristic to obtain a similarity between the first voiceprint characteristic and the pre-stored reference voiceprint characteristic, comparing the similarity with a preset threshold, and determining that the first voiceprint characteristic is consistent with the reference voiceprint characteristic in response to the similarity larger than the preset threshold at S13, and determining a wake-up word included in content of the voice signal by using a wake-up word recognition model and waking up the voice interaction device at S14.

In a possible implementation, the acquiring a voice signal at S11 may include receiving an audio signal and extracting the voice signal from the audio signal. The audio signal is an information carrier that carries a change in frequency and amplitude of a regular sound wave with voice, music and sound effects. By using characteristics of the sound wave, the voice signal can be extracted from the audio signal.

In a possible implementation, the extracting a first voiceprint characteristic of the voice signal at S12 may be performed by applying a voiceprint recognition technology. A voiceprint is a sound wave spectrum that carries linguistic information, which is displayed by an electroacoustic instrument. The voiceprint characteristics between any two people are different, and each person's voiceprint characteristics are relatively stable. The voiceprint recognition may be categorized into two types, i.e., the text-dependent voiceprint recognition and the text-independent voiceprint recognition. The text-dependent voiceprint recognition system requires users to pronounce according to specified content, and voiceprint models for respective users are accurately established one by one. The users may pronounce according to the specified content during an identification process. The text-independent voiceprint recognition system does not require the users to pronounce according to specified content. In an embodiment of the present application, a text-independent voiceprint recognition method can be adopted. When the voiceprint characteristic is extracted and compared, a voice signal with any content may be used rather than a voice signal including specified content.

In a possible implementation, multiple reference voiceprint characteristics may be pre-stored. For example, a voice interaction device may be used by multiple users, thus these users may be viewed as the “master” of the voice interaction device. In an embodiment of the present application, the voiceprint characteristics of a user may be considered as one reference voiceprint characteristic, and a plurality of reference voiceprint characteristics for multiple users may be stored. Specifically, the multiple reference voiceprint characteristic may be determined by acquiring a voice signal of at least one user, extracting a second voiceprint characteristic of each user's voice signal, and determining each of the second voiceprint characteristics as the reference voiceprint characteristic. In order to determine the reference voiceprint characteristic, a recording apparatus may be used and turned on with the user's consent when the voice signal of each user is acquired, in order to record voice signals of the users in various scenes in life.

Accordingly, in a possible implementation, the comparing the first voiceprint characteristic with a pre-stored reference voiceprint characteristic to obtain a similarity between the first voiceprint characteristic and the pre-stored reference voiceprint characteristic, comparing the similarity with a preset threshold, and determining that the first voiceprint characteristic is consistent with the reference voiceprint characteristic in response to the similarity larger than the preset threshold at S13 may include: comparing the first voiceprint characteristic with pre-stored reference voiceprint characteristics to obtain similarities between the first voiceprint characteristic and the respective pre-stored reference voiceprint characteristics; comparing the similarities with a preset threshold; and determining that the first voiceprint characteristic is consistent with one of the reference voiceprint characteristics in response to the similarity between the first voiceprint characteristic and the one of the reference voiceprint characteristics larger than the preset threshold.

For example, N (N is a positive integer) reference voiceprint characteristics are pre-stored. In the comparison process, the first voiceprint characteristic is sequentially compared with each of the N reference voiceprint characteristics. Once the first voiceprint characteristic is consistent with a certain reference voiceprint characteristic, it is determined that the comparison result is a consistency, then the comparison process is finished. In case that the first voiceprint characteristic is inconsistent with any of the reference voiceprint characteristics, it is determined that the comparison result is an inconsistency. Alternatively, the first voiceprint characteristic may be compared with each of the N reference voiceprint characteristics respectively to obtain N comparison results, and each comparison result indicates a similarity between the first voiceprint characteristic and a corresponding reference voiceprint characteristic. Then, a comparison result with the maximum similarity may be obtained. In case that the maximum similarity is larger than a preset similarity threshold, it is determined that the first voiceprint characteristic is consistent with the corresponding reference voiceprint characteristic. In case that the maximum similarity is not larger than the preset similarity threshold, it is determined that the first voiceprint characteristic is inconsistent with any of the reference voiceprint characteristics.

In a possible implementation, a wake-up word recognition model associated with each of the reference voiceprint characteristics may be established in advance. For example, for N users of a voice interaction device, the voiceprint characteristics of the N users are extracted in advance, and these voiceprint characteristics of the N users are determined as N reference voiceprint characteristics. Then N wake-up word recognition models are established respectively for the N reference voiceprint characteristics. The correspondence relations between the users, the reference voiceprint characteristics, and the wake-up word recognition models may be as shown in Table 1 below.

TABLE 1

| | Reference voiceprint | Wake-up word recognition |
|---|---|---|
| User | characteristic | model |
| User 1 | Reference voiceprint | Wake-up word recognition |
| | characteristic 1 | model 1 |
| User 2 | Reference voiceprint | Wake-up word recognition |
| | characteristic 2 | model 2 |
| . . . | . . . | . . . |
| User N | Reference voiceprint | Wake-up word recognition |
| | characteristic N | model N |

When the wake-up word recognition model is established, the wake-up word recognition model may be trained with a positive sample and a negative sample having corresponding reference voiceprint characteristics respectively, wherein the positive sample is a voice signal including the wake-up word and capable of waking up the voice interaction device, and the negative sample is a voice signal that does not include the wake-up word and is capable of waking up the voice interaction device.

The wake-up word is not included in the negative sample, but due to some factors such as the user's accent, the voice interaction device may recognize the wake-up word from the negative sample and be woken up. In this case, it is a false wake-up.

For example, “Xiaodu Xiaodu” may be preset as a wake-up word for a voice interaction device.

When a voice signal with content of “Xiaodu Xiaodu” is provided by a user, the voice signal may be converted into textual information by the voice interaction device. In case that the converted textual information is “Xiaodu Xiaodu”, the voice interaction device can be woken up. The voice signal with content of “Xiaodu Xiaodu” provided by the user is then a positive sample.

However, when a voice signal with content of “Xiaotu, Xiaotu” is provided by a user, the voice signal can also be converted into textual information by the voice interaction device. The pronunciation of “Xiaotu, Xiaotu” is similar to the pronunciation of “Xiaodu Xiaodu”, and the deviation may be determined due to the user's accent. Therefore, the voice interaction device may still convert the voice into “Xiaodu, Xiaodu”. In this case, the voice interaction device can still be woken up. However, the wake-up word is not included in the voice signal provided by the user, and the user actually does not want to wake up the voice interaction device. Thus, a false wake-up is happened. The voice signal with the content of “Xiaotu, Xiaotu” provided by the user is provided as a negative sample.

In an embodiment of the present application, the wake-up word recognition model may be trained by using a positive sample and a negative sample, and the wake-up voice signal can be correctly identified, thereby reducing the possibility that the voice interaction device is woken up falsely.

In a possible implementation, a plurality of negative samples may be recorded and gradually accumulated while the voice interaction device is used by a user. Then, the wake-up word recognition model may be further trained by using the positive sample and the accumulated negative samples, to enable the determination result of the wake-up word recognition model to be more accurate.

Accordingly, the determining a wake-up word included in the content of the voice signal by using a wake-up word recognition model at S14 may include: determining a reference voiceprint characteristic consistent with the first voiceprint characteristic, obtaining a wake-up word recognition model associated with the determined reference voiceprint characteristic, and determining the voice signal by using the obtained wake-up word recognition model.

For example, in an embodiment, the first voiceprint characteristic of the acquired voice signal is consistent with the reference voiceprint characteristic 2 in Table 1. Then, the wake-up word recognition model 2 corresponding to the reference voiceprint characteristic 2 is obtained, and the wake-up word recognition model 2 is used to determine the wake-up word included in the voice signal.

In a possible implementation, the foregoing comparison and determination may be performed in cloud. Alternatively, the reference voiceprint characteristic and the wake-up word recognition model may be sent to the voice interaction device, and then the above-mentioned comparison and determination is performed by the voice interaction device, thereby improving the efficiency of wake-up.

Embodiments of the present application may be applied to devices with voice interaction functions, including but not limited to smart speakers, smart speakers with screens, televisions with voice interaction functions, smart watches, and in-vehicle intelligent voice devices. In the case of low security requirements, it can support controllable adjustment of error rejection rate and error acceptance rate, and appropriately reduce the error rejection rate of the above-mentioned comparison and determination and avoid that no response to a voice signal provided by a user including the wake-up word occurs.

For example, referring to the above S13, in an initial state, the criterion of determining that the first voiceprint characteristic is consistent with the reference voiceprint characteristic may be set as: in case that the similarity between the first voiceprint characteristic and the reference voiceprint characteristic is larger than 90%, it is determined that the two are consistent. During the use of a voice interaction device, in case that there are frequent occurrences of no responding to a voice signal provided by a user, the above criterion may be appropriately lowered. For example, the criterion of determining that the comparison result is a consistency may be set as: in case that the similarity between the first voiceprint characteristic and the reference voiceprint characteristic is larger than 80%, it is determined that the two are consistent. On the contrary, during the use of the voice interaction device, in case that there are frequent occurrences of responding to a voice signal provided by a non-user and then waking up falsely, the above criterion may be appropriately improved. For example, the criterion of determining that the comparison result is a consistency may be set as: in case that the similarity between the first voiceprint characteristic and the reference voiceprint characteristic is larger than 95%, it is determined that the two are consistent.

For another example, the voice signal is input into the wake-up word recognition model, and then the wake-up word recognition model may output a probability value indicating the possibility that a wake-up word is included in the voice signal. The larger the probability, the greater the possibility that the wake-up word recognition model can predict that the wake-up word is included in the content of the voice signal. When the probability is larger than a preset threshold, the wake-up word recognition model determines that the voice signal includes the wake-up word. Referring to the above S14, during the use of the voice interaction device, in case that there are frequent occurrences of responding to a voice signal provided by a user, the threshold may be appropriately lowered. On the contrary, during the use of the voice interaction device, in case that there are frequent occurrences of responding to a voice signal provided by a non-user and then waking up falsely, the above threshold can be appropriately increased.

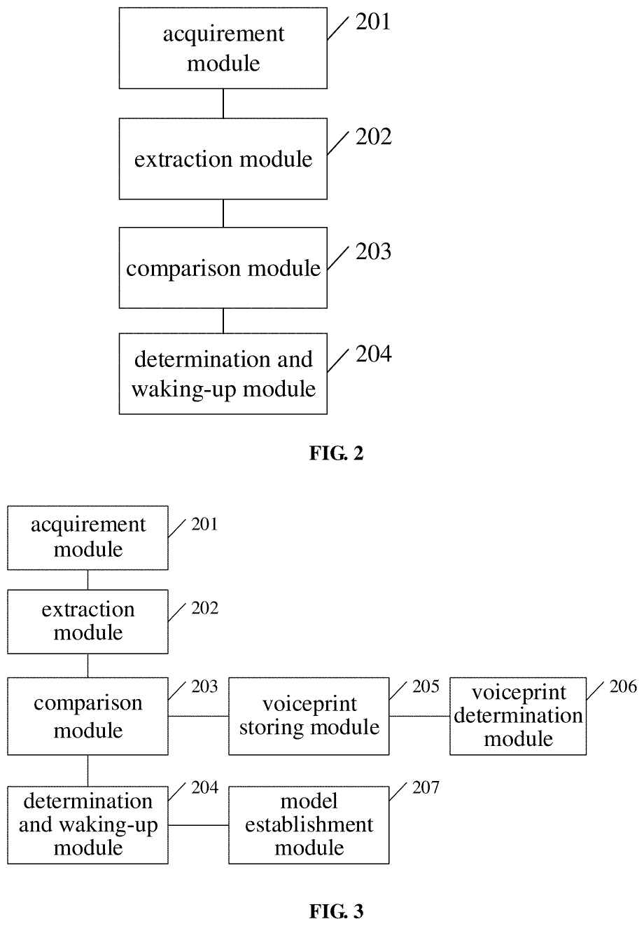

An apparatus for waking up a voice interaction device is further provided according to an embodiment of the present application. FIG. 2 is a schematic structural diagram showing an apparatus for waking up a voice interaction device according to an embodiment of the present application. As shown in FIG. 2, the apparatus includes an acquirement module 201 configured to acquire a voice signal, an extraction module 202 configured to extract a first voiceprint characteristic of the voice signal, a comparison module 203 configured to compare the first voiceprint characteristic with a pre-stored reference voiceprint characteristic to obtain a similarity between the first voiceprint characteristic and the pre-stored reference voiceprint characteristic, compare the similarity with a preset threshold, and determine that the first voiceprint characteristic is consistent with the reference voiceprint characteristic in response to the similarity larger than the preset threshold, and a determination and waking-up module 204 configured to determine a wake-up word included in content of the voice signal by using a wake-up word recognition model and waking up the voice interaction device.

FIG. 3 is another schematic structural diagram showing an apparatus for waking up a voice interaction device according to an embodiment of the present application. The apparatus includes an acquirement module 201, an extraction module 202, a comparison module 203, and a determination and waking-up module 204. The four modules are the same as the corresponding modules in the foregoing embodiment, and thus a detailed description thereof is omitted herein.

The apparatus further includes a voiceprint storing module 205 configured to store a plurality of reference voiceprint characteristics. The comparison module 203 is further configured to compare the first voiceprint characteristic with pre-stored reference voiceprint characteristics to obtain similarities between the first voiceprint characteristic and the respective pre-stored reference voiceprint characteristics, comparing the similarities with a preset threshold, and determining that the first voiceprint characteristic is consistent with one of the reference voiceprint characteristics in response to the similarity between the first voiceprint characteristic and the one of the reference voiceprint characteristics larger than the preset threshold.

In a possible implementation, the apparatus further includes a voiceprint determination module 206 configured to acquire a voice signal of a user, extract a second voiceprint characteristic of the voice signal of the user, and determine the second voiceprint characteristic as the reference voiceprint characteristic.

In a possible implementation, the apparatus further includes a model establishment module 207 configured to establish a wake-up word recognition model associated with the reference voiceprint characteristic in advance. The determination and waking-up module 204 is further configured to determine a reference voiceprint characteristic consistent with the first voiceprint characteristic, obtain a wake-up word recognition model associated with the determined reference voiceprint characteristic, and determine the voice signal by using the obtained wake-up word recognition model.

In a possible implementation, the model establishment module 207 is further configured to train the wake-up word recognition model with a positive sample and a negative sample having the reference voiceprint characteristic, wherein the positive sample is a voice signal including the wake-up word and capable of waking up the voice interaction device, and the negative sample is a voice signal that does not include the wake-up word and is capable of waking up the voice interactive device.

In this embodiment, functions of modules in the apparatus refer to the corresponding description of the method mentioned above and thus a detailed description thereof is omitted herein.

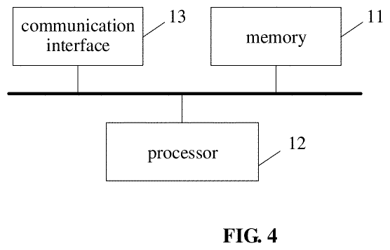

As shown in FIG. 4, a device for waking up a voice interaction device is provided according to an embodiment of the present application. The device includes a memory 11 and a processor 12, wherein a computer program that can run on the processor 12 is stored in the memory 11. The processor 12 executes the computer program to implement the method for waking up a voice interaction device according to the foregoing embodiments. The number of either the memory 11 or the processor 12 may be one or more.

The device may further include a communication interface 13 configured to communicate with an external device and exchange data.

The memory 11 may include a high-speed RAM memory and may also include a non-volatile memory, such as at least one magnetic disk memory.

If the memory 11, the processor 12, and the communication interface 13 are implemented independently, the memory 11, the processor 12, and the communication interface 13 may be connected to each other via a bus to realize mutual communication. The bus may be an Industry Standard Architecture (ISA) bus, a Peripheral Component Interconnected (PCI) bus, an Extended Industry Standard Architecture (EISA) bus, or the like. The bus may be categorized into an address bus, a data bus, a control bus, and the like. For ease of illustration, only one bold line is shown in FIG. 4 to represent the bus, but it does not mean that there is only one bus or one type of bus.

Optionally, in a specific implementation, if the memory 11, the processor 12, and the communication interface 13 are integrated on one chip, the memory 11, the processor 12, and the communication interface 13 may implement mutual communication through an internal interface.

In the description of the specification, the description of the terms “one embodiment,” “some embodiments,” “an example,” “a specific example,” or “some examples” and the like means the specific features, structures, materials, or characteristics described in connection with the embodiment or example are included in at least one embodiment or example of the present application. Furthermore, the specific features, structures, materials, or characteristics described may be combined in any suitable manner in any one or more of the embodiments or examples. In addition, different embodiments or examples described in this specification and features of different embodiments or examples may be incorporated and combined by those skilled in the art without mutual contradiction.

In addition, the terms “first” and “second” are used for descriptive purposes only and are not to be construed as indicating or implying relative importance or implicitly indicating the number of indicated technical features. Thus, features defining “first” and “second” may explicitly or implicitly include at least one of the features. In the description of the present application, “a plurality of” means two or more, unless expressly limited otherwise.

Any process or method descriptions described in flowcharts or otherwise herein may be understood as representing modules, segments or portions of code that include one or more executable instructions for implementing the steps of a particular logic function or process. The scope of the preferred embodiments of the present application includes additional implementations where the functions may not be performed in the order shown or discussed, including according to the functions involved, in substantially simultaneous or in reverse order, which should be understood by those skilled in the art to which the embodiment of the present application belongs.

Logic and/or steps, which are represented in the flowcharts or otherwise described herein, for example, may be thought of as a sequencing listing of executable instructions for implementing logic functions, which may be embodied in any computer-readable medium, for use by or in connection with an instruction execution system, device, or apparatus (such as a computer-based system, a processor-included system, or other system that fetch instructions from an instruction execution system, device, or apparatus and execute the instructions). For the purposes of this specification, a “computer-readable medium” may be any device that may contain, store, communicate, propagate, or transport the program for use by or in connection with the instruction execution system, device, or apparatus. The computer readable medium of the embodiments of the present application may be a computer readable signal medium or a computer readable storage medium or any combination of the above. More specific examples (not a non-exhaustive list) of the computer-readable media include the following: electrical connections (electronic devices) having one or more wires, a portable computer disk cartridge (magnetic device), random access memory (RAM), read only memory (ROM), erasable programmable read only memory (EPROM or flash memory), optical fiber devices, and portable read only memory (CDROM). In addition, the computer-readable medium may even be paper or other suitable medium upon which the program may be printed, as it may be read, for example, by optical scanning of the paper or other medium, followed by editing, interpretation or, where appropriate, process otherwise to electronically obtain the program, which is then stored in a computer memory.

It should be understood various portions of the present application may be implemented by hardware, software, firmware, or a combination thereof. In the above embodiments, multiple steps or methods may be implemented in software or firmware stored in memory and executed by a suitable instruction execution system. For example, if implemented in hardware, as in another embodiment, they may be implemented using any one or a combination of the following techniques well known in the art: discrete logic circuits having a logic gate circuit for implementing logic functions on data signals, application specific integrated circuits with suitable combinational logic gate circuits, programmable gate arrays (PGA), field programmable gate arrays (FPGAs), and the like.

Those skilled in the art may understand that all or some of the steps carried in the methods in the foregoing embodiments may be implemented by a program instructing relevant hardware. The program may be stored in a computer-readable storage medium, and when executed, one of the steps of the method embodiment or a combination thereof is included.

In addition, each of the functional units in the embodiments of the present application may be integrated in one processing module, or each of the units may exist alone physically, or two or more units may be integrated in one module. The above-mentioned integrated module may be implemented in the form of hardware or in the form of software functional module. When the integrated module is implemented in the form of a software functional module and is sold or used as an independent product, the integrated module may also be stored in a computer-readable storage medium. The storage medium may be a read only memory, a magnetic disk, an optical disk, or the like.

In summary, by applying the method and apparatus for waking up a voice interaction device according to embodiments of the present application, after a voice signal is acquired, it is firstly determined whether a similarity between a voiceprint characteristic of the voice signal and pre-stored a reference voiceprint characteristic is larger than a preset threshold. In case that the similarity is larger than the preset threshold, it is determined that the voiceprint characteristic of the voice signal is consistent with the pre-stored reference voiceprint characteristic. Then, a wake-up word included in content of the voice signal is determined by using a wake-up word recognition model, and the voice interaction device is woken up. Through the step-by-step determinations, the ratio for falsely waking up a voice interactive device may be reduced.

The foregoing descriptions are merely specific embodiments of the present application, but not intended to limit the protection scope of the present application. Those skilled in the art may easily conceive of various changes or modifications within the technical scope disclosed herein, all these should be covered within the protection scope of the present application. Therefore, the protection scope of the present application should be subject to the protection scope of the claims.

What is claimed is:

1. A method for waking up a voice interaction device, comprising:
acquiring a voice signal;
extracting a first voiceprint characteristic of the voice signal;
comparing the first voiceprint characteristic with a pre-stored reference voiceprint characteristic to obtain a similarity between the first voiceprint characteristic and the pre-stored reference voiceprint characteristic; comparing the similarity with a preset threshold; and determining that the first voiceprint characteristic is consistent with the reference voiceprint characteristic in response to the similarity larger than the preset threshold; and
determining a wake-up word included in content of the voice signal by using a wake-up word recognition model and waking up the voice interaction device.

2. The method according to claim 1, further comprising: pre-storing a plurality of reference voiceprint characteristics; and
the comparing the first voiceprint characteristic with a pre-stored reference voiceprint characteristic to obtain a similarity between the first voiceprint characteristic and the pre-stored reference voiceprint characteristic; comparing the similarity with a preset threshold; and determining that the first voiceprint characteristic is consistent with the reference voiceprint characteristic in response to the similarity larger than the preset threshold comprises:
comparing the first voiceprint characteristic with pre-stored reference voiceprint characteristics to obtain similarities between the first voiceprint characteristic and the respective pre-stored reference voiceprint characteristics; comparing the similarities with a preset threshold; and determining that the first voiceprint characteristic is consistent with one of the reference voiceprint characteristics in response to the similarity between the first voiceprint characteristic and the one of the reference voiceprint characteristics larger than the preset threshold.

3. The method according to claim 1, further comprising: determining the reference voiceprint characteristic by:
acquiring a voice signal of a user, extracting a second voiceprint characteristic of the voice signal of the user, and determining the second voiceprint characteristic as the reference voiceprint characteristic.

4. The method according to claim 1, further comprising:
establishing a wake-up word recognition model associated with the reference voiceprint characteristic in advance; and
the determining a wake-up word included in content of the voice signal by using a wake-up word recognition model comprises: determining a reference voiceprint characteristic consistent with the first voiceprint characteristic; obtaining a wake-up word recognition model associated with the determined reference voiceprint characteristic; and determining the voice signal by using the obtained wake-up word recognition model.

5. The method according to claim 4, wherein the establishing a wake-up word recognition model associated with the reference voiceprint characteristic in advance comprises:
training the wake-up word recognition model with a positive sample and a negative sample having the reference voiceprint characteristic, wherein the positive sample is a voice signal including the wake-up word and capable of waking up the voice interaction device, and the negative sample is a voice signal that does not include the wake-up word and is capable of waking up the voice interactive device.

6. An apparatus for waking up a voice interaction device, comprising:
one or more processors; and
a memory for storing one or more programs, wherein
the one or more programs are executed by the one or more processors to enable the one or more processors to:
acquire a voice signal;
extract a first voiceprint characteristic of the voice signal;
compare the first voiceprint characteristic with a pre-stored reference voiceprint characteristic to obtain a similarity between the first voiceprint characteristic and the pre-stored reference voiceprint characteristic; compare the similarity with a preset threshold; and determine that the first voiceprint characteristic is consistent with the reference voiceprint characteristic in response to the similarity larger than the preset threshold; and
determine a wake-up word included in content of the voice signal by using a wake-up word recognition model and waking up the voice interaction device.

7. The apparatus according to claim 6, wherein the one or more programs are executed by the one or more processors to enable the one or more processors to:
store a plurality of reference voiceprint characteristics; and
compare the first voiceprint characteristic with pre-stored reference voiceprint characteristics to obtain similarities between the first voiceprint characteristic and the respective pre-stored reference voiceprint characteristics; comparing the similarities with a preset threshold; and determining that the first voiceprint characteristic is consistent with one of the reference voiceprint characteristics in response to the similarity between the first voiceprint characteristic and the one of the reference voiceprint characteristics larger than the preset threshold.

8. The apparatus according to claim 6, wherein the one or more programs are executed by the one or more processors to enable the one or more processors to:
acquire a voice signal of a user, extract a second voiceprint characteristic of the voice signal of the user, and determine the second voiceprint characteristic as the reference voiceprint characteristic.

9. The apparatus according to claim 6, wherein the one or more programs are executed by the one or more processors to enable the one or more processors to: establish a wake-up word recognition model associated with the reference voiceprint characteristic in advance; and
determine a reference voiceprint characteristic consistent with the first voiceprint characteristic; obtain a wake-up word recognition model associated with the determined reference voiceprint characteristic; and determine the voice signal by using the obtained wake-up word recognition model.

10. The apparatus according to claim 9, wherein the one or more programs are executed by the one or more processors to enable the one or more processors to: train the wake-up word recognition model with a positive sample and a negative sample having the reference voiceprint characteristic, wherein the positive sample is a voice signal including the wake-up word and capable of waking up the voice interaction device, and the negative sample is a voice signal that does not include the wake-up word and is capable of waking up the voice interactive device.

11. A non-transitory computer-readable storage medium, in which a computer program is stored, wherein the computer program, when executed by a processor, causes the processor to implement the method of claim 1.
